(19) United States
(12) Patent Application Publication
(10) Pub. No.: US 2017/0208021 A1
(43) Pub. Date: Jul. 20, 2017

(54) ADAPTIVE NUDGE MESSAGES TO MOTIVATE INDIVIDUALS TO ACHIEVE CERTAIN WELLNESS GOALS

(71) Applicant: Welltok, Inc., Denver, CO (US)

(72) Inventors: Paul Ingram, Poulsbo, WA (US); Travis McElfresh, Redmond, WA (US); Brian Garcia, Highlands Ranch, CO (US)

(21) Appl. No.: 14/996,850

(22) Filed: Jan. 15, 2016

(51) Int. Cl. H04L 12/58; G06F 19/00; H04L 29/08

(52) U.S. Cl. CPC H04L 51/02; H04L 67/22; G06F 19/3481; G08B 21/24

(57) ABSTRACT

A message management system that sends customized messages to help a user achieve wellness objectives. The message management system is used in conjunction with a wellness system that allows users to participate in various wellness programs to improve the user's well-being. Until the user has completed the selected wellness program, the management system may send “nudge messages” to the user depending on the user's progress within the program or other factors. Generally, a nudge message comprises motivational content delivered to the user at a certain time to motivate the user to complete one or more tasks and progress towards the overall goal. Nudge messages are delivered to the user via one or more communication channels that are most likely to cause the message to reach a user and have a desired motivating effect. Effects of nudge messages are measured by the system and used to modify future nudge messages.

### BACKGROUND

Individuals often desire to improve their well-being, such as by exercising more or eating healthier. As committed as people are to achieve wellness improvements, however, all too often people's commitment falls short. After an enthusiastic start, people lose motivation and fail to follow through with activities necessary to achieve their desired goals. Some individuals are fortunate enough to have a coach, mentor, friends or family that encourage the individual to stick with their intended plan. Such support can be critical in order to keep the individual progressing towards the goal. Unfortunately, such personal support is not always available to everyone, or is not available on a consistent basis. Without support, many individuals ultimately stop progressing towards their goal and eventually give up the effort. It would therefore be desirable to identify a mechanism to motivate individuals to continue with a wellness plan in order to achieve a desired goal.

### BRIEF DESCRIPTION OF THE DRAWINGS

Various embodiments are disclosed in the following detailed description and accompanying drawings.

FIGS. 1A-1C illustrate an example scenario in which a message management system is used to send nudge messages to a user.

FIG. 2 illustrates an example environment in which the message management system operates.

FIG. 3 illustrates a representative list of modules in the message management system.

FIG. 4 illustrates a process performed by the message management system to help a user achieve wellness objectives.

FIG. 5 is a representative data table used to track the impact of nudge messages received by a user.

FIG. 6 contains a high-level block diagram showing an example architecture of a computing device.

### DETAILED DESCRIPTION

A message management system that sends customized nudge messages to help a user achieve wellness objectives is disclosed herein. The message management system is integral to, or used in support of, a wellness system that allows users to participate in various wellness programs to improve the user's mental or physical well-being. A user initially selects a wellness program having one or more goals. Each goal is typically defined by one or more tasks that are to be completed within a certain timeframe. For example, the overall goal of a selected wellness program may be to reduce stress during a one week period. The tasks in the selected wellness program may be to take a five-minute walk outside the office twice during the work day, to watch a short instructional video on stress reduction, and for the user to journal thoughts at the end of each day. Until the user has completed the selected wellness program, the management system may send “nudge messages” to the user depending on the user's progress within the program or other factors. Generally, a nudge message comprises motivational content delivered to the user at a certain time to help motivate the user to complete one or more tasks and progress towards the overall goal. A nudge message can include an inspiration, an encouragement, a piece of advice, an acknowledgement, an affirmation, a reminder of an ultimate goal, or whatever content helps the user complete a task or tasks. The message may be an image, audio such as a spoken message or a song, a video, a textual message, or any combination thereof that might have a motivational impact on the user. For purposes of discussion herein, the motivational content delivered in the nudge message shall be referred to generically as the message “content.”

Nudge messages are delivered to the user via one or more communication channels, depending on the communication channel most likely to cause the message to reach a user and have a desired motivating effect. For example, the nudge message may be an electronic message sent to the mobile device of a user, a recorded message placed to a landline of the user, or a postcard physically mailed to a user. In some embodiments, the same nudge message may be sent to the user via multiple communication channels at the same or at different times.

The message management system monitors the effectiveness of the nudge messages that are sent to a user. Nudge messages that cause a user to complete tasks or achieve goals within a desired timeframe are noted as being more effective by the system. In contrast, nudge messages that do not cause a user to complete tasks or achieve goals within a desired timeframe are noted as being less effective. When sending future nudge messages to the user, the system takes into account the effectiveness of past nudge messages when selecting the content of the nudge message, timing of the nudge message, or communication channel of the nudge message in order to increase the likely effectiveness of the nudge message.

Various embodiments of the invention will now be described. The following description provides specific details for a thorough understanding and an enabling description of these embodiments. One skilled in the art will understand, however, that the invention may be practiced without many of these details. Additionally, some well-known structures or functions may not be shown or described in detail, so as to avoid unnecessarily obscuring the relevant description of the various embodiments. The terminology used in the description presented below is intended to be interpreted in its broadest reasonable manner, even though it is being used in conjunction with a detailed description of certain specific embodiments of the invention.

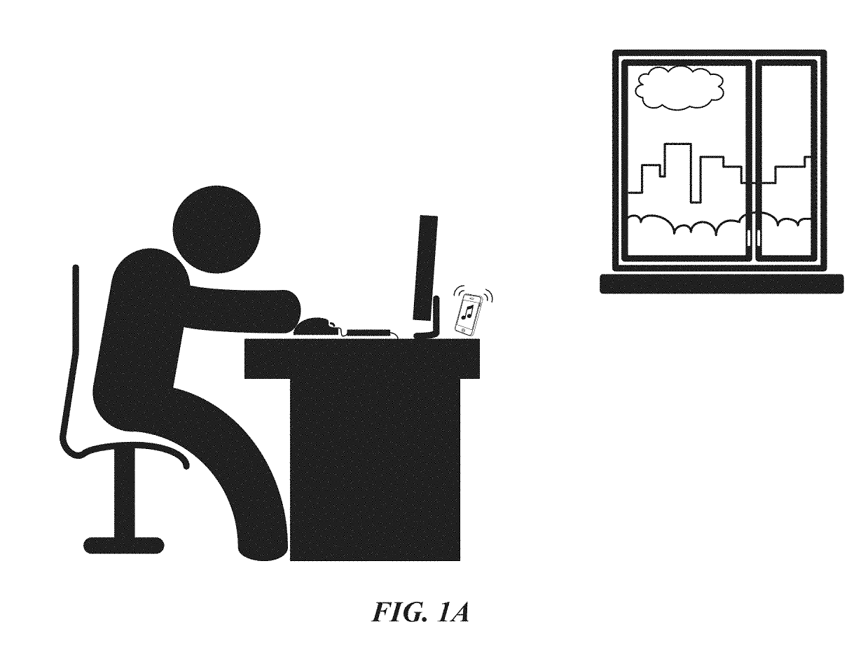

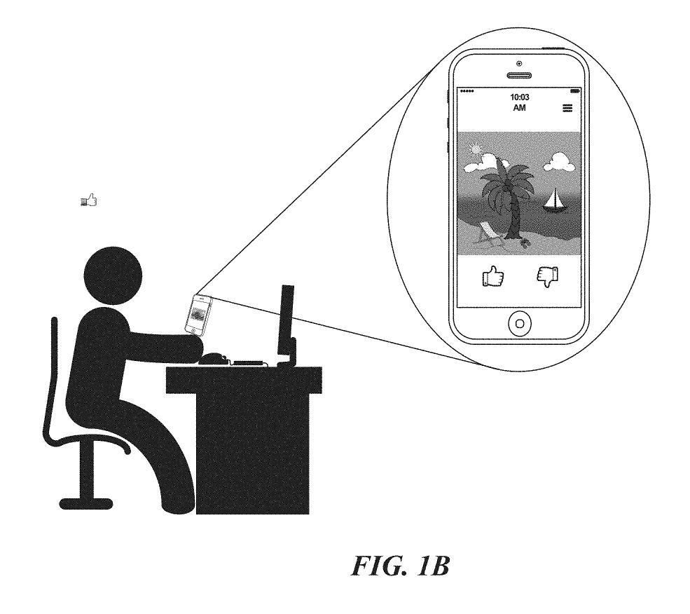

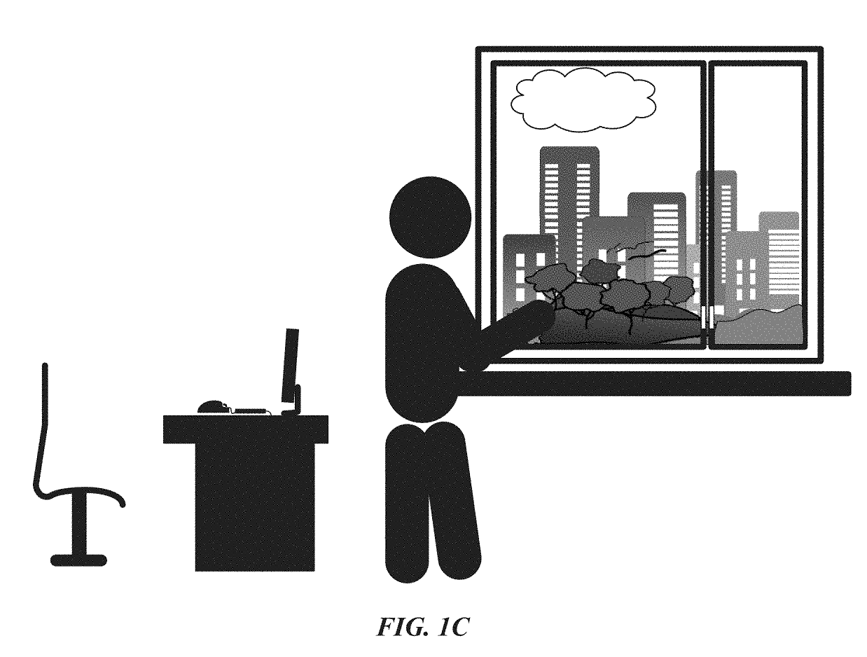

FIGS. 1A-1C illustrate an example scenario in which the message management system operates. Continuing with the previous example, the user may have elected to participate in or otherwise have been assigned to a wellness program designed to reduce the user's stress. FIG. 1A shows a user working diligently on a computer during the workday. In order to motivate the user to make progress in the selected wellness program, the management system sends a nudge message to the user. The management system selects a time, a communication channel, and content to send to the user. For example, the management system may send the nudge message to a mobile phone associated with the user at 10 am in the morning. The mobile phone notifies the user of the receipt of the nudge message with an alert, such as a sound or visual indication.

FIG. 1B shows the user responding by immediately picking up the mobile phone to review the content of the nudge message. The management system may record the sending and viewing of the nudge message by the user. In terms of the content of the nudge message, the user may have previously indicated to the system that the user loves the beach and often takes vacations to islands. Therefore, the management system includes a photo of a beach in the nudge message to remind the user of relaxing vacations that the user has taken in the past. Such a message reinforces the wellness program goal of relaxation, as well as inherently (although not explicitly) reminds the user to continue to complete tasks associated with the selected program. In the event that the user does not pick up the mobile phone and continues working on the computer instead, the management system may send the same nudge message to the user after a certain time has elapsed. Note that the nudge message that is sent to the user is expressly not a reminder to complete a task, meaning that the sending of the nudge message is not timed to occur when a user should complete a certain task within the wellness program nor does the message content necessarily refer to an outstanding task. Instead, the nudge message contains content that encourages the user towards the intended goal at a time when the user is in need of encouragement. Often an encouraging word, image, or song received at an opportune time is sufficient to re-motivate an individual to stick to an intended wellness program.

FIG. 1C shows that in response to reviewing the nudge message and being reminded of the beach, the user decides to walk to the window to see the outdoors, thereby taking a break from the computer. Without expressly providing instructions to the user, the nudge message has had the desired effect to cause the user to step away from the workstation for a few minutes and take a break. The message system may estimate the effectiveness of the nudge message in a variety of ways. For example, the message management system records when the user viewed the nudge message. The system may also note if the user never views the nudge message. As another example, the message management system may receive express feedback from the user on the effectiveness of the nudge message. For example, the user may respond to the nudge message with an indication that the message was liked or appreciated. The message management system may also receive indirect feedback on the effectiveness of the nudge message from the user's actions. For example, the message management system may receive an indication of whether the user completed the overall wellness program within a specified timeframe. If the wellness program was completed within the specified timeframe, the system may infer that the nudge messages were effective.

By analyzing recorded user behavior or receiving direct user feedback, the management system modulates the sending of nudge messages to a user. As the message management system sends more nudge messages to the user and also across a population of users, the system is able to better model the appropriate content, time, and communication channel with which to send a nudge message. Such adaptation allows the system to more effectively target nudge messages to help a user complete the task or tasks associated with a selected wellness program.

By virtue of at least the features noted above, the message management system provides a user with customized encouragement or motivation in conjunction with a wellness program. The management system adapts to the preferences of a user and how a user reacts to the received nudge messages. Accordingly, the management system helps the user achieve an optimal result from the wellness program.

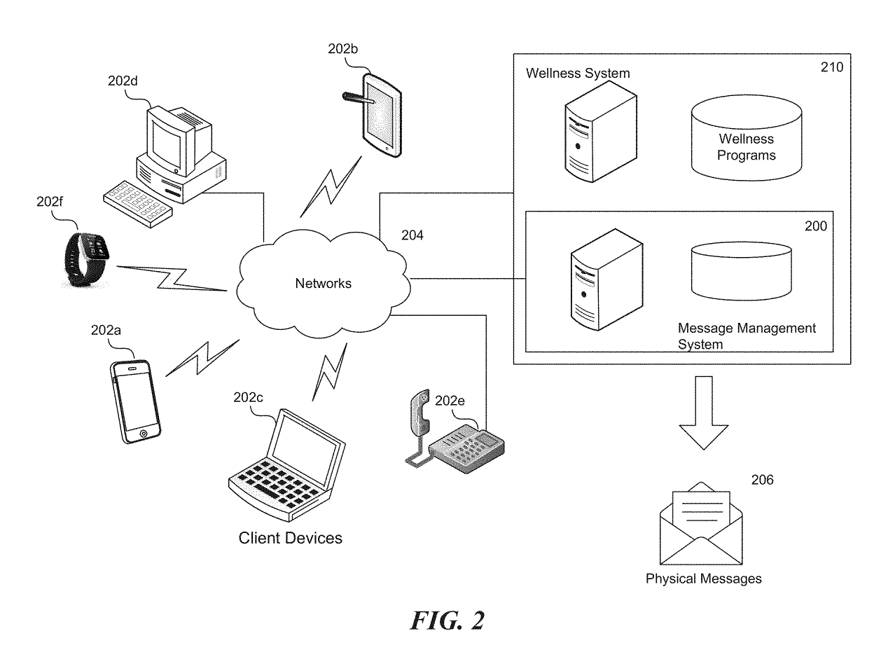

FIG. 2 illustrates an example environment in which a message management system 200 operates. In some embodiments, the management system 200 comprises one or more processors and storage devices. The management system 200 has sufficient capabilities for large-scale data processing, storage, communication, etc. The management system 200 can be implemented on a cloud-computing platform, on one more servers, etc. Data utilized by the system may be stored in structured or unstructured databases.

The message management system 200 operates as part of, or in conjunction with, a wellness system 210. The wellness system 210 allows users to participate in various wellness programs to improve the participating user's mental or physical well-being. The wellness system 210 provides users access to different wellness programs via an online portal or an application operating on desktop or mobile computing devices. Each wellness program has one or more goals for a user to achieve. A goal may be to improve a particular lifestyle skill, such as to sleep better, eat better, exercise more, perform certain activities to mitigate the risk of or effect of a particular health condition, etc. Each goal is typically defined by one or more tasks that are to be completed within a certain timeframe. For example, a task might be to watch a particular video, to perform a certain activity, to answer a set of questions, etc. The wellness system 210 manages the presentation of tasks to the user (including, for example, the streaming of videos, provision of educational content, presentation of surveys or quizzes to a user, etc.), and tracks completion of the tasks though certain direct or indirect methods described in additional detail herein. Users that complete all tasks of a wellness program within a particular time frame demonstrate to the wellness system 210 that they have mastered the skills represented in that program. The time frame in which a particular wellness program is to be completed may be set by the wellness system. For example, a relaxation wellness program may have a fixed two week length in which it is to be completed. Alternatively, a user may be allowed to specify a length of time in which they would like to complete a selected wellness program. For example, the system may allow the user to specify that they would like to complete the relaxation wellness program within 4 weeks. By successful completion of programs, users hopefully improve their overall life and well-being.

The message management system 200 operates in conjunction with the wellness system 210 to periodically send nudge messages to users to help users stay on track to complete selected wellness programs. To send nudge messages, the message management system 200 includes a communication component that facilitates communication to or from client devices 202 across networks 204. Client devices 202 can be a mobile phone 202a, a tablet 202b, a laptop computer 202c, a desktop computer 202d, a wearable device such as a smartwatch 202f, etc. To communicate with users that don't have a mobile device or computer, the client device 202 may also be a landline phone 202d. Networks 204 are public or private, wired or wireless networks, such as the Internet, government, or corporate networks. In addition or in lieu of communicating with a client device, the message management system 200 may also have the capability to cause physical mail 206 to be sent to a user. For example, the message management system 200 may have the capability to cause personalized postcards or letters to be printed and mailed to the user.

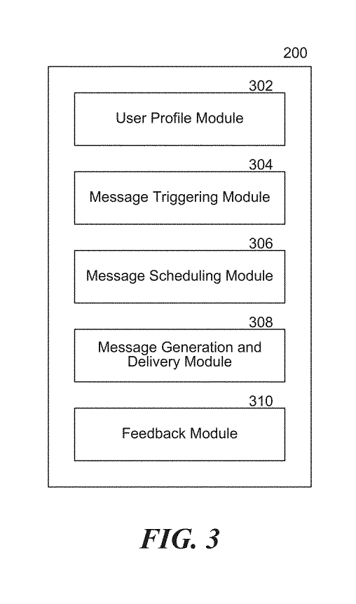

FIG. 3 illustrates a representative set of modules of the management system 200. In some embodiments, the management system comprises a user profile module 302, a message triggering module 304, a message scheduling module 306, a message generation and delivery module 308, and a feedback module 310. The functionality of each module will be described in turn herein.

The user profile module 302 maintains a profile of a user that is to receive nudge messages. Each user profile contains a variety of information that may be used by the system to tailor nudge messages to the user. For example, the profile may contain demographic and personal information about the user, such as the user's age, gender, birthdate, marital status, home address, phone number, medical conditions, etc. The profile may include various information about the user's favorite activities (e.g., sports, hobbies, vacation destinations), the user's favorite music (e.g., bands, songs, genres of music) or video (e.g., movies, television shows), or friends and family (e.g., links to friends or family on Facebook™, LinkedIn™, or other social media platforms). A record of the general likes and dislikes of the user allows the system to identify nudge content that is likely to be more compelling and effective to move the user to action. The system also may also use such information to avoid certain types of content that are perceived to be de-motivating to the individual (e.g., sending a pop music video to a user that has an interest in classical music).

The stored user profile may also contain express user preferences for nudge messages, such as desired communication channels, desired nudge formats (e.g., text message, email, video versus static images), and desired time and/or frequency of nudges. The user can specify conditions under which nudge messages can be received with certain complex formulations. Those formulations may be based on any combination of type of content, day or time of day, and communication channel. For example, the user can indicate that a nudge message should not contain audio when the user is in the office. As another example, the user may specify that they would only like to receive nudge messages between the hours of 8 am and 5 pm during the work week, but between the hours of 10 am and 6 pm on weekends. As yet another example, a user can specify receiving nudge messages on a mobile phone identified by a mobile number when the user is in a certain location, but receiving nudge messages on a wearable device when the user is at any other location.

Data contained in the user profile may be expressly provided by the user, such as in response to a registration form or survey that is presented to the user by the wellness system 210 or message management system 200 when registering for a wellness program. Data may also be collected by the system based on responses to nudge messages that might be sent to the user. For example, the system may solicit feedback on a nudge message that is sent to the user (“did you like this image?” or “click here to stop sending me nudges like this” or by use of like and dislike icons as depicted in FIG. 1B) and record response received from the user. The user profile module 302 stores the various pieces of data in the user's account. As the system learns more about content that is effective on each user, the system may update the stored profile information to reflect the interests of the user. As will be described, the system 200 sends nudge messages to the user in a customized manner using such stored information.

In addition to storing information about the user and the user's preferences, the user profile module 302 also maintains a record of the current wellness programs that a user is currently undertaking, as well as a record of any past wellness programs that the user has already completed. As previously described, each wellness program typically encompasses one or more goals. In order to reach the goal or goals, the user must complete one or more tasks within a particular timeframe. To track the user's progress within a particular wellness program, the system may directly or indirectly receive progress updates about the user. For example, the message management system 200 may receive an indication of progress within a program from the wellness system 210. The received indication of progress may include an express list of tasks that have already been completed by a user in the wellness program. The completed tasks may be based on detected physical activities of the user (e.g., receiving an indication from a wearable computing device that the user walked 10,000 steps today), or based on known educational content delivered to the user via a computing device (e.g., the presentation of an educational video or quiz to the user by the system). Alternatively, the received indication of progress may be an indication of the portion of the wellness program that had been completed as of the time of progress update. For example, the wellness system might indicate that the user had completed 37% of a wellness program as of 1 pm today, or completed 12 of 17 tasks as of the time the progress update was transmitted. The received progress data provides the system 200 with likely locations of the user within the wellness program and a general sense of the pace of the user towards completing the wellness program.

Additionally, the user profile module 302 also maintains information about the current context of the user. “Context” refers to any information characterizing the current state of the user, such as the physical location of the user (e.g., at home versus at work, travelling on vacation versus located in the city where the user resides), the current time of day where the user is located, and the current day of the week (e.g., weekday versus weekend). As part of receiving context information, the message management system may also receive information from user devices about the recent motion of the user. For example, a user's smartphone or smartwatch may contain various sensors, such as a GPS module, a motion detector, a heart monitor, or other monitoring component that monitors the user's body functions. The message management system 200 can receive the sensor data from these devices and assess the location of the user and whether the user has recently completed, or is currently participating in, any physical exercise or movement.

A nudge triggering module 304 recommends potentially sending a nudge message to a user based on the user's pace in a particular wellness program or based on another condition indicating that a nudge message may be warranted. The triggering module may recommend sending a nudge message to a user when the user is behind, on, or ahead of schedule in a particular wellness program, although typically nudge messages are more likely to be sent when a user has fallen behind a desired pace within the wellness program. Although the nudge analysis is initially triggered by the user's pace within a wellness program or other condition, as will be described herein the system modulates when to actually send nudge messages is based on the user's current context, the user's preferences, the user's reaction to previous nudge messages, and other factors.

On a periodic or continuous basis, the nudge triggering module 304 compares a user's location in each wellness program in which the user is participating with the corresponding program parameters in order to assess whether the user is ahead of, at, or behind the expected program pace. If the user falls behind the program pace by a particular threshold, the nudge triggering module 304 determines that the user is a suitable candidate for receiving a nudge message. In such circumstances, the nudge message is intended to help motivate the user to re-engage with the wellness program. In some embodiments, the nudge triggering module 304 may also detect other conditions which could reflect a likely slowdown in pace of completing a wellness program. The detection of such conditions indicates that the user is a suitable candidate for receiving a nudge message. Some conditions that may indicate the user is a candidate for a nudge message include the weather (e.g., if it has rained for several days at a location of the user), a time of year (e.g., nudge messages may be more beneficial during the holiday season), or a physical state of the user (for example, a wearable device on the user may report that the user has had a poor night of sleep and therefore may benefit from a nudge message). In some embodiments, the nudge triggering module 304 will also randomly determine an appropriate time to send nudge messages to a user, even if the user is at or ahead of an expected program pace. Such random nudge messages act to re-affirm and continue to motivate the user to participate in the selected wellness program.

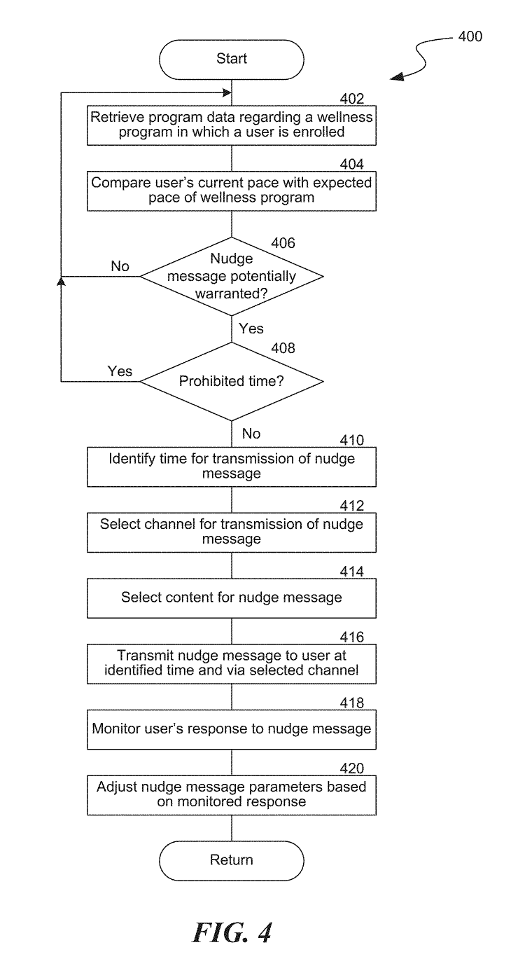

FIG. 4 is a flow diagram of a process 400 executed by the message management system 200 to construct and send nudge messages to a user. The process 400 is executed by the message management system for each wellness program associated with a user. In block 402, the nudge triggering module 304 retrieves program data regarding a wellness program in which the user is participating. The program data includes, for each of the program goals, task data describing one or more tasks associated with the goal, and pacing data specifying timing constraints for performing the one or more tasks in order to achieve the program goal or goals within a desired timeframe. In some circumstances, the pacing data is an average rate that each task must be completed in order for a wellness goal to be achieved within a particular timeframe. For example, if a wellness program lasts 2 weeks and has 8 tasks, the user must complete 4 tasks each week or approximately 1 task every 2 days in order to maintain the appropriate program pace. Determining pacing based on average rate of task completion is agnostic to complexity or length of each individual task. In some circumstances, the pacing data is a particular task schedule associated with the wellness program. For example, the wellness program may have tasks assigned in a particular order or schedule. For example, task 1 must be completed by day 1, tasks 2-3 by day 2, tasks 4-6 by day 3, etc. When a particular program task schedule is specified, the user must maintain the schedule in order to be on track to complete the program within the desired timeframe.

At block 404, the management system 200 determines whether the user is at, on, or behind the appropriate pace for the wellness program and therefore might be a suitable candidate for receiving a nudge message. To determine whether the user is on pace for the wellness program, the nudge triggering module 304 compares the current time/date with the corresponding order and schedule of the wellness program. The comparison may be based on the average rate of task completion. For example, if the user is expected to complete 15 tasks in a selected wellness program within two weeks, and the user has only completed 4 tasks after the first five days, the nudge triggering module identifies that the user has fallen behind the task completion pace necessary to complete the program within the specified timeframe and is therefore a candidate for receiving a nudge message. The comparison may also be a direct comparison of tasks already completed by the user with a task schedule associated with the wellness program. If, as of the date checked, the user has not completed the required tasks within the specified timeframe, the user is identified as a candidate for receiving a nudge message.

In addition to assessing whether the user is behind pace at block 404, the nudge triggering module 304 may also randomly recommend that the user should receive a nudge message even though the user is at or ahead of pace for the corresponding wellness program. Such random assignment ensures that even users who are successfully executing on a wellness program may periodically receive nudge messages for encouragement.

In addition to assessing whether the user is behind pace at block 404, the nudge triggering module 304 may also detect other conditions which might impact the user's pace in completing a wellness program. Using the current location of the user, the nudge triggering module 304 may access online services (e.g., The Weather Channel™) to determine the current weather that the user is experiencing. If the current weather matches stored profiles of weather patterns that are likely to demotivate users (e.g., if it has rained for several days at the user's location, if heavy snowfall has occurred where the user is located), the user may be identified as a candidate to receive a nudge message. The nudge triggering module 304 may also access certain personal data reflecting a physical state of the user. For example, the nudge triggering module 304 may examine data from a user's wearable device and analyze the sleep pattern of the user over several nights. If the sleep pattern of the user matches stored sleep patterns reflecting poor sleep (e.g., the user is getting up multiple times during a night, the user has only had short amounts of sleep for several nights in a row), the user may be identified as a candidate to receive a nudge message. The detection of these or other conditions by the nudge triggering module 304 indicate that the user is a suitable candidate to receive a nudge message.

At decision block 406, the nudge triggering module 304 determines whether the user is a candidate for a nudge message. If the user is not a candidate, processing returns to block 402 where another wellness program in which the user is enrolled is evaluated. If the user is a candidate for a nudge message, however, processing continues block 408. At this point, the user is merely a candidate for receiving a nudge message. Whether a nudge message is actually sent, and the actual timing of the nudge message, depends on other user-specific factors that are assessed by the messaging system 200.

Returning to FIG. 3, once a user is identified as a candidate to receive a nudge message by the message triggering module 304, the message scheduling module 306 assesses other factors to determine if and when the nudge message should actually be sent and by which communication channel. Returning to FIG. 4, as a first factor, at decision block 408 the message scheduling module 306 checks the user's preferences in the user profile to determine whether the current time falls within an express prohibition against nudge messages that has been specified by a user. If a user has currently prohibited nudge messages, the message scheduling module 306 identifies a first time in the future when nudge messages are not prohibited by the user. When that time is reached, the system re-assesses the trigger conditions surrounding the nudge message to determine whether the conditions still warrant the sending of a nudge message. If the current time is not prohibited by the user, however, processing continues to block 410.

If a user has not prohibited sending nudge messages at the evaluated time, the message scheduling module 306 evaluates other contextual factors to identify appropriate timing to send a nudge message. Such contextual factors may include, for example, the current date and time, the user's current location, and any current activities of the user. The current activities of the user can be derived from activity sensor data indicating, for example, that the user is currently active (e.g., walking or running) or is currently sedentary. The current activities of a user can also be gleaned, for example, by using APIs to access information from social media platforms (e.g., Facebook™) to interpret recent posts indicating the current activities of the user. Using obtained contextual information, the message scheduling module 304 applies certain business rules to the contextual information to schedule the nudge message. For example, nudge messages may be found to be more effective when received immediately after the completion of certain physical activities. The message scheduling module 306 may therefore schedule the nudge message to be sent upon detecting that the user has completed any current activity. As another example, nudge messages may be found to be more effective when received during the afternoon, at a low point of a user's wake cycle, than when received at the end of the day immediately before the user goes to sleep for the night. The message scheduling module 306 may therefore schedule the nudge message to be sent in the mid-afternoon to the user. As yet another factor, as will be described in additional detail herein, the message management system 200 is always measuring feedback on the efficacy of past nudge messages that are transmitted to a user. Information about efficacy of past nudge messages that are delivered to a user is therefore used to guide the current scheduled time of the nudge message that is to be delivered to the user. For example, if past nudge messages that were delivered early in the morning to the user were determined by the system to be particularly effective in motivating the user's participation in a wellness program, then the system will weight mornings more heavily when assessing when to deliver nudge messages to the user. A rule applying all of these factors may thus be to schedule the nudge message to be sent between the hours of 2 pm-4 pm, provided that the user is not active during that period and provided that messages sent during that period have been effective in the past, otherwise to send the message in the evening. Applying the business rules to the contextual information, and applying any weightings based on past observed timing of nudge messages to the user, the message scheduling module 306 schedules an appropriate time for the nudge message to be sent to the user.

Once the timing of the nudge message has been determined at block 410, at block 412 the message scheduling module 306 determines an appropriate communication channel by which to transmit the message to the user. The message scheduling module 306 initially accesses the user profile to determine whether the user has specified the use of any particular communication channel. If the user has specified a particular communication channel (e.g., a mobile device), then the message scheduling module 306 selects that channel with which to send the nudge message. If the user has not specified the use of any particular communication channel, the message scheduling module 306 uses the obtained contextual information and applies certain business rules to the contextual information to select the communication channel. For example, nudge messages may be found to be more effective when received via a wearable computing device (e.g., a smartwatch) if the user is performing a physical activity, but via email sent to a desktop computer if the user is at work. As yet another factor, information about the efficacy of past communication channels used to send nudge messages to a user is used to guide the current selection of the communication channel. For example, if past nudge messages that were delivered to the user via a smartphone were determined by the system to be particularly effective in motivating the user's participation in a wellness program, then the system will weight the smartphone communication channel more heavily when assessing the channel to use for nudge messages. Applying the business rules to the contextual information, as well as any weightings based on past observed efficacy of communication channels with the user, the message scheduling module 306 selects a communication channel to use to send a nudge message to a user. Note that not all communication channels require the user to have a computing device to receive the message. For some users without access to technology, the nudge message may be scheduled by the message scheduling module 306 for delivery via postal mail or via a recorded call that is autodialed to a user's landline.

Returning to FIG. 3, once the time and communication channel are selected for the nudge message, the message management system 200 selects the content of the message that is to be transmitted to the user. The message generation and delivery module 308 selects content to provide notification, encouragement, inspiration, or acknowledgement to the user related to the performance of one or more tasks within the wellness program. As was previously noted, the nudge message that is sent to the user is expressly not a reminder message, meaning that the sending of the nudge message is not timed to occur to remind a user to complete a certain task. Instead the nudge message contains content that motivates the user towards the intended goal at a time when the user is in need of encouragement. Often an encouraging word, image, or song received at an opportune time is sufficient to re-motivate an individual to stick to an intended wellness program. The message generation and delivery module 308 selects content from one or more databases of stored content that is maintained by the message management system 200. Stored content is curated by the operator of the message management system 200. That is, the operator may identify inspirational text, songs, videos, etc. and manage the identified content so that it remains topical and popular. The content may be organized by subject, by keywords or tags, by type of content, etc., and accessed by the system based on any of the foregoing. If certain content is found to not motivate users, the content may be dropped from the curated dataset by the message management system 200.

Returning to FIG. 4, at a block 414 the message generation and delivery module 308 selects the motivational content for the nudge message. In order to select motivational content, the message generation and delivery module 308 uses information from the user profile to identify content that may be motivating to the user. For example, information about the user's “likes” that is stored in the user profile of the user may be used in a search query to identify potentially suitable content for the user. The identified content may be filtered to select the specific content to send to the user by applying certain business rules based on contextual or other information about the user. As an example, a certain song from a musical group that the user likes may be a nice reminder for the user to take a few minutes to relax as part of a stress reduction wellness program to which a user subscribes. As yet another factor, information about the efficacy of content sent to a user in the past is used to guide the current selection of content. For example, if past nudge messages containing particular quotes from famous authors was determined by the system to be particularly effective in motivating the user's participation in past wellness programs, then the system will be biased towards selecting additional motivational quotes to send to the user. Applying the business rules to the contextual information, as well as applying any learnings based on past observed efficacy of content with the user, the message generation and delivery module 308 selects content to populate the nudge message. Of course, in the absence of specific information about a user, the message generation and delivery module 308 may instead rely upon content that has been found to be generally effective across a broad population of users. For example, certain nudge messages showing pictures of beaches may be found to generally motivate people whose wellness program contains a goal of losing a few pounds for an upcoming vacation. As such, the system may make a content decision based on general efficacy as well.

After selecting content for the nudge message, at a block 412 the message generation and delivery module 308 transmits the message to the user at the appropriate time and via the appropriate channel. The transmission may be sent in a manner that the message management system 200 is able to confirm that the user has received and viewed/accessed the message, or the message may be sent in a fashion that the system is unable to determine that the user has received and viewed/accessed the message.

Returning to FIG. 3, once the system has transmitted a nudge message to the user, the feedback module 310 attempts to assess the impact of the nudge message on the user's behavior. In some embodiments, the feedback module 310 analyzes a user's reaction to nudge messages and then modulates the process of sending nudge messages to the user by changing when to send nudge messages, what to send as nudge messages, and how to send nudge messages. The feedback module 310 directly determines a user's reaction by receiving a user response or by detecting an immediate change of behavior of the user, or indirectly be monitoring the effect that the nudge message has on the user's progress in the wellness program.

In some cases, the feedback module 310 is able to detect a direct change in user behavior as a result of an immediate response or a change in action of the user. For example, a nudge message that is emailed to the user may contain a simple “thumbs up” or “thumbs down” icon on the message. A user may immediately respond to the received nudge message by pressing either icon to indicate to the system whether the nudge message was favorably or unfavorably received. In other cases, the system may be able to detect an immediate change in behavior of the user based on sensors associated with the user. For example, a user in a sedentary state may immediately get up and walk around after receiving a nudge message. Such movement may be detected by a wearable computing device sensor on the user, and transmitted back to the system. In the first case, the system has direct feedback on the favorable effect in the nudge message. In the second case, the system has indirect feedback of the effect of the nudge message, particularly if the change in state is one of the desired activities in the wellness program. Of course, with any nudge message sent to a user, the user can respond immediately, can respond with delay, or the user may not respond at all within a certain period of time.

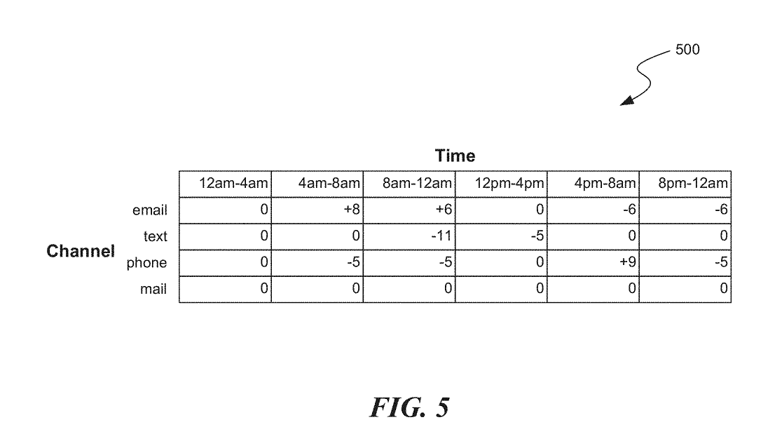

Based on the user's reaction, the feedback module 310 records either a positive reaction, a neutral (or no) reaction, or a negative reaction to the nudge message and the parameters of the nudge message. For example, if a user consistently provides a “thumbs down” response to nudge messages received at 6 am in the morning, the system may store an indication that early nudge messages are disfavored. FIG. 5 is a representative table 500 that the system may maintain for each user to record the estimated impact of each nudge message received by the user. The table in FIG. 5 tracks the perceived impact of nudge message by communication channel (represented by the rows in the table) and by time (represented by each column in the table). For each favorable impact, the system increments the corresponding number in the table by one. For each unfavorable impact, the system decrements the corresponding number in the table by one. For each neutral impact, the system does not change the corresponding number in the table. Over time, the data recorded in the table can be used to predict the best time and the best communication channel in which to reach a user. For example, the sample data provided in table 500 indicates that the represented user responds more favorably to email messages during the hours from 4 am-12 pm (as reflected by the positive numbers in the table) and less favorably to email messages during the hours from 4 pm to 12 am (as reflected by the negative numbers). Conversely, the represented user responds favorably to phone calls during the hours from 4 pm-8 pm, but not to phone calls at other hours of the day. Moreover, the highly negative numbers in the table indicates that the user likely does not like receiving nudge messages via text.

It will be appreciated by one skilled in the art that the table 500 is merely representative of the type of data that might be stored by the message management system 200. Different parameters may be tracked, such as the user's reaction to different types of content that are contained in a nudge message. Different data resolutions may be used, for example, the hours of the day may be broken into 24 one-hour periods. And different mechanisms may be used to track the impact of the nudge messages. The data in the table may be continuously updated by the system, or may be updated on a periodic basis.

Returning to FIG. 4, in some cases at block 414 the feedback module 310 is unable to detect an immediate change in user behavior as a result of a response or change in action of the user. In that case, the system may monitor the aggregate impact of sending nudge messages to a user on the user's completion of wellness programs within a desired timeframe. Such impact is measured by tracking the number, content, time, and communication channel of nudge messages sent to a user, and comparing the sent messages with information received from the wellness system 210 about the completion pace of the user in the one or more wellness programs. Using various sampling methodologies and applying machine learning or multivariate analysis to identify those nudge message parameters that are significantly correlated with the user's wellness program performance, the feedback module 310 is able to estimate the impact of number, content, time, and communication channel on performance of wellness programs. Such analysis may be provided on an individual user basis, or across multiple users that participate in the same wellness programs. Using such information, the feedback module 310 is able to modulate future nudge messages to a user in order improve the effectiveness of nudge messages.

As the feedback module 310 is able to develop a large dataset over an extended period of time pertaining to the efficacy of nudge messages, the feedback module 310 is able to better guide the message management system 200 in what to send as nudge messages and how to send nudge messages to the user. Such information may include the frequency of sending nudge messages, timing within a day of nudge messages, the expressiveness of the content of a nudge message, the format of a nudge message, the medium on which to present a nudge message, etc. Of course, the feedback module 310 may also be able to assess which type of nudge messages are largely ineffective, and thereby discontinue use of such nudge messages.

In some embodiments, the feedback module 310 examines data regarding the user's reaction to nudge messages for only a specific type of goals or for a specific type of wellness program. For example, the feedback module 310 may only evaluate the efficacy of nudge messages for wellness programs that include tasks involving physical activity (e.g., walking, running, exercising) and not evaluate the efficacy of nudge messages for wellness programs that only involve viewing videos and completing a survey. The feedback module may ignore nudge messages for such wellness programs, since nudge messages might be known to be generally less effective in those types of wellness programs. Moreover, the feedback module 310 can also examine data across certain groups of users to identify characteristics of nudge messages that are generally effective in helping users complete the necessary tasks. Once a like group of users are identified, the feedback module can apply learnings from that group to new users having characteristics that would place them in the group.

Returning to FIG. 4, at block 412, the message management system 200 modulates the process of sending nudge messages based on the completed analysis. Specifically, the management system adjusts the values of certain message parameters in order to improve the user's overall performance in the wellness program, thereby helping the user achieve desired wellness objectives. By adapting nudge messages to the preferences of individual users, the disclosed management system 200 offers a significant performance improvement over prior systems that merely acted as a task reminder.

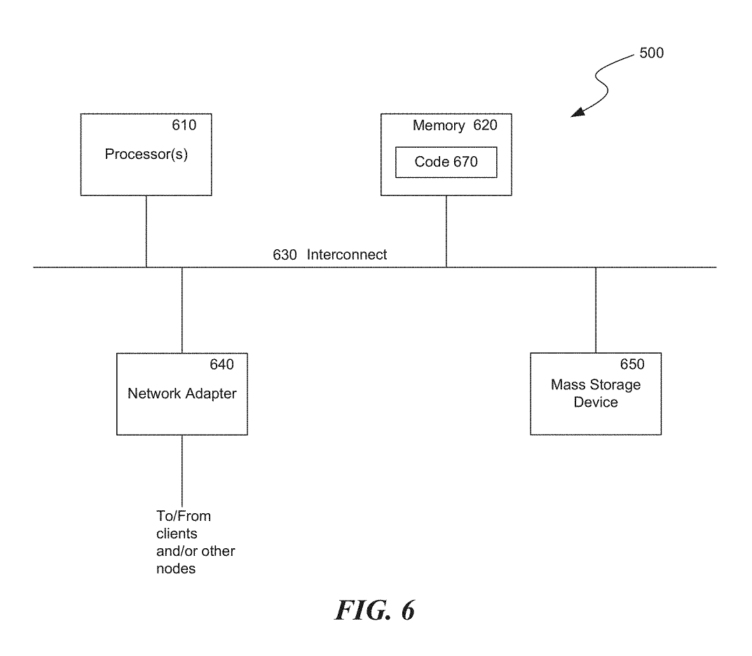

FIG. 6 contains a high-level block diagram showing an example architecture of a computer, which may represent any electronic device, such as a mobile device or a server, including any node within a cloud service as described herein, such as may implement the operations described above. The computer 600 includes one or more processor(s) 610 and memory 620 coupled to an interconnect 630. The interconnect 630 shown in FIG. 6 is an abstraction that represents any one or more separate physical buses, point to point connections, or both, connected by appropriate bridges, adapters, or controllers. The interconnect 630, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, also called Firewire.

The processor(s) 610 are the central processing unit (CPU) of the computer 600 and thus control the overall operation of the computer 600. In certain embodiments, the processor(s) 610 accomplish this by executing software or firmware stored in memory 620. The processor(s) 610 may be, or may include, one or more programmable general-purpose or special-purpose microprocessors, digital signal processors (DSPs), programmable controllers, application specific integrated circuits (ASICs), programmable logic devices (PLDs), field-programmable gate arrays (FPGAs), trusted platform modules (TPMs), or a combination of such or similar devices.

The memory 620 is or includes the main memory of the computer 600. The memory 620 represents any form of random-access memory (RAM), read-only memory (ROM), flash memory, or the like, or a combination of such devices. In use, the memory 620 may contain code 670 containing instructions according to the techniques disclosed herein.

Also connected to the processor(s) 610 through the interconnect 630 are a network adapter 640 and a mass storage device 650. The network adapter 640 provides the computer 600 with the ability to communicate with remote devices over a network and may be, for example, an Ethernet adapter. The network adapter 640 may also provide the computer 600 with the ability to communicate with other computers.

The code 670 stored in memory 620 may be implemented as software and/or firmware to program the processor(s) 610 to carry out actions described above. In certain embodiments, such software or firmware may be initially provided to the computer 600 by downloading it from a remote system through the computer 600 (e.g., via network adapter 640).

The techniques introduced herein can be implemented by, for example, programmable circuitry (e.g., one or more microprocessors) programmed with software and/or firmware, or entirely in special-purpose hardwired circuitry, or in a combination of such forms. Software or firmware for use in implementing the techniques introduced herein may be stored on a machine-readable storage medium and may be executed by one or more general-purpose or special-purpose programmable microprocessors.

The various embodiments are described above with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

A machine-readable storage medium, as the term is used herein, includes any mechanism that can store information in a form accessible by a machine (a machine may be, for example, a computer, network device, mobile phone, personal digital assistant (PDA), manufacturing tool, or any device with one or more processors, etc.). For example, a machine-accessible storage medium includes recordable/non-recordable media (e.g., ROM, RAM, magnetic disk storage media, optical storage media, flash memory devices, etc.) or other types of media.

The aforementioned flowchart and diagrams illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special-purpose hardware-based systems that perform the specified functions, or acts or combinations of special-purpose hardware and computer instructions.

Furthermore, it is to be understood that the invention can be carried out or practiced in various ways and that the invention can be implemented in embodiments other than the ones outlined in the description above.

I/we claim:

1. A method performed by a computing system comprising a processor and a memory of transmitting nudge messages to a user to help the user achieve a wellness goal, the method comprising:
retrieving from a database, by the computing system, program data regarding a wellness program in which the user participates, the wellness program comprising one or more goals, wherein the program data includes, for each of the goals of the wellness program, task data regarding a plurality of tasks and timing data associated with the goal;
monitoring, by the computing system, the performance by the user of the plurality of tasks associated with the wellness program;
when the user falls behind a desired pace in the performance of the plurality of tasks in the wellness program, constructing a nudge message having a plurality of attributes to be transmitted to the user, the plurality of attributes comprising content to be delivered to the user, a time at which the nudge message is to be sent to the user, and a communication channel by which to send the nudge message;
sending, by the computing system, the constructed nudge message to the user over the communication channel at the time;
determining a response of the user to the sent nudge message;
analyzing, by the computing system, a relationship between attributes of the sent nudge message and the user response to the sent nudge message; and
adjusting, by the computing system, the plurality of attributes of subsequent nudge messages to be sent to the user based on the analyzed relationship.

2. The method of claim 1, wherein the timing data associated with each goal includes an overall deadline for completing the goal.

3. The method of claim 1, wherein the timing data associated with each goal includes timing associated with each of the plurality of tasks associated with the goal.

4. The method of claim 1, wherein determining the response of the user to the sent nudge message comprises receiving a direct response from the user to the nudge message.

5. The method of claim 4, wherein the response is a reply to a text or email message.

6. The method of claim 1, wherein determining the response of the user to the sent nudge message comprises measuring whether the nudge message changed the pace of the user in achieving the one or more goals.

7. The method of claim 1, further comprising receiving tracking data regarding performance or non-performance of any of the plurality of tasks associated with the one or more goals.

8. The method of claim 7, wherein the tracking data is received from a fitness tracking device or from a mobile device associated with the user.

9. The method of claim 1, wherein the desired pace is determined based on a completion rate of the plurality of tasks.

10. The method of claim 1, wherein the content in the nudge message comprises text, audio, an image, a video, or multimedia.

11. The method of claim 1, wherein the communication channel comprises an email, a text, a phone call, a social media platform, a website, or physical mail.

12. The method of claim 1, wherein the user receives the nudge message on a mobile phone, a laptop computer, a desktop computer, a tablet, or a wearable device.

13. The method of claim 1, further comprising randomly sending a user a nudge message regardless of whether the user falls behind the desired pace in the performance of the plurality of tasks in the wellness program.

14. The method of claim 1, wherein the analyzing further includes determining correlations between one or more of the attributes of nudge messages and responses of the user using multivariate or machine learning analysis.

15. A system for adaptively helping a user achieve wellness objectives by the sending of nudge messages, the system comprising:
a processor and a memory, cooperating to function as:
a first retrieving unit configured to receive program data regarding a plurality of wellness programs associated with a user, each wellness program comprising one or more goals from a database, wherein the program data includes, for each of the goals, task data regarding at least one task and timing data associated with the goal;
a second receiving unit configured to receive a set of preferences regarding attributes of nudge messages from the client device of a user over a computer network, wherein a nudge message is digital content to be delivered to a device associated with the user at a point in time;
a sending unit configured to transmit nudge messages associated with the plurality of wellness programs over the computer network in accordance with the set of preferences;
a monitoring unit configured to monitor responses of the user to the transmitted nudge messages;
an analyzing unit configured to analyze a relationship between the attributes of nudge messages and responses of the user based on the transmitted nudge messages and the responses of the user to the nudge messages; and
an adjusting unit configured to adjust values of the attributes of future nudge messages to be transmitted by the user over the computer network based on the analyzed relationship, to improve responses of the user to the nudge messages.

16. The system of claim 15, wherein the response of the user to the sent nudge message comprises receiving a direct response from the user to the nudge message.

17. The system of claim 16, wherein the response is a reply to a text or email message.

18. The system of claim 15, wherein the response of the user to the sent nudge message comprises measuring whether the nudge message changed the pace of the user in achieving the one or more goals.

19. The system of claim 15, wherein the digital content in the nudge message comprises text, audio, an image, a video, or multimedia.

20. A non-transitory computer-readable storage medium whose contents cause a computing system to perform a method of transmitting nudge messages to a user to help the user achieve a wellness goal, the method comprising:
retrieving from a database, by the computing system, program data regarding a wellness program in which the user participates, the wellness program comprising one or more goals, wherein the program data includes, for each of the goals of the wellness program, task data regarding a plurality of tasks and timing data associated with the goal;
monitoring, by the computing system, the performance by the user of the plurality of tasks associated with the wellness program;
when the user falls behind a desired pace in the performance of the plurality of tasks in the wellness program, constructing a nudge message having a plurality of attributes to be transmitted to the user, the plurality of attributes comprising content to be delivered to the user, a time at which the nudge message is to be sent to the user, and a communication channel by which to send the nudge message;
sending, by the computing system, the constructed nudge message to the user over the communication channel at the time;
determining a response of the user to the sent nudge message;
analyzing, by the computing system, a relationship between attributes of the sent nudge message and the user response to the sent nudge message; and
adjusting, by the computing system, the plurality of attributes of subsequent nudge messages to be sent to the user based on the analyzed relationship.
